(19) United States
(12) Patent Application Publication
(10) Pub. No.: US 2015/0051984 A1
(43) Pub. Date: Feb. 19, 2015

(54) Value-Based Content Distribution

(71) Applicant: GOOGLE INC., Mountain View, CA (US)

(72) Inventor: Patrick Hummel, Cupertino, CA (US)

(73) Assignee: GOOGLE INC., Mountain View, CA (US)

(21) Appl. No.: 13/966,583

(22) Filed: Aug. 14, 2013

(51) Int. Cl. G06Q 30/02

(52) U.S. Cl. CPC G06Q 30/0275
USPC 705/14.71

(57) ABSTRACT

Methods, systems, and apparatus, including computer programs encoded on a computer storage medium, for distributing content are disclosed. In one aspect, a method includes identifying a sponsor value that was used to select a content item for presentation in the first presentation position. The sponsor value can be determined based on a current bid associated with the content item and one or more previous bids that were previously associated with the content item. A first lower value of the sponsor value that will result in the content item being presented at a different presentation position of the resource is identified. A price to be charged for presentation of the content item is determined based on a bid value corresponding to the sponsor value and a difference in performance of the content item at the first presentation position and the different presentation position.

### BACKGROUND

This specification relates to data processing and content distribution.

The Internet facilitates the exchange of information and transactions between users across the globe. This exchange of information enables content sponsors to provide sponsored content to a variety of users. A content sponsor can control the distribution of their content items (e.g., promotions, advertisements, audio files, video files, or other content items) based on a set of distribution parameters that specify under what conditions a content item is eligible to be distributed. When a presentation opportunity meeting the conditions is available, the content item provided by a content sponsor is deemed eligible to be provided for presentation.

### SUMMARY

In general, one innovative aspect of the subject matter described in this specification can be embodied in methods that include the actions of identifying, for a content item that was selected for presentation in a first presentation position of a resource that includes at least two presentation positions, a sponsor value that was used to select the content item for presentation in the first presentation position, the sponsor value being a value determined based on a current bid associated with the content item and one or more previous bids that were previously associated with the content item; identifying a first lower value of the sponsor value that will result in the content item being presented at a different presentation position of the resource; obtaining a first estimated performance for the content item at the first presentation position and a second estimated performance for the content item at the different presentation position; and determining a price to be charged for presentation of the content item at the first presentation position based on a first bid value that results in the sponsor value meeting the first lower value and a difference between the first estimated performance and the second estimated performance. Other embodiments of this aspect include corresponding systems, apparatus, and computer programs, configured to perform the actions of the methods, encoded on computer storage devices.

These and other embodiments can each optionally include one or more of the following features. Methods can include the actions of determining that a lower presentation position is available; determining a second lower value of the sponsor value that will result in the content item being presented in the lower presentation position; and determining a third estimated performance of the content item at the lower presentation position.

Determining a price that will be charged can include determining a performance weighted average of the first bid value and a second bid value that results in the sponsor value meeting the second lower value, a first weight assigned to the first bid value being based on a difference between the first estimated performance and the second estimated performance, a second weight assigned to the second bid value being based on a difference between the second estimated performance and the third estimated performance.

Identifying a first lower value can include identifying a sponsor value at which a first sponsor value of a particular content sponsor associated with the content item falls below a second sponsor value of another content item sponsor that has been selected to provide a content item in one of the at least two presentation positions.

Methods can include the actions of determining the second sponsor value based on a current bid associated with the other content sponsor, a cumulative distribution function associated with the other content sponsor, and a probability density function associated with the other content sponsor.

Identifying a bid value at which a first sponsor value of the content sponsor falls below meets the first lower value can include determining, for the particular content sponsor, a cumulative distribution function based on bids that have been previously received from the particular content sponsor; determining, for the particular content sponsor, a probability density function, based on the cumulative distribution function; and determining a bid value at which an output of a function of the bid value, the cumulative distribution function, and the probability density function meet the first lower value.

Methods can include the actions of identifying a final lower value at which the content item will no longer be presented, wherein determining a price that will be charged comprises determining the price based on the bid that provides the first lower value, the final lower value, and the second estimated performance.

Particular embodiments of the subject matter described in this specification can be implemented so as to realize none, one or more of the following advantages. A price paid by a content sponsor for each impression (or click) is determined based on a performance weighted average of bid values at which the content sponsor would be allocated various available presentation positions, which encourages a content sponsor to bid a full value of an impression (or click) because the price paid by the content sponsor depends on values other the content sponsor's bid. Publishers are encouraged to accurately specify a maximum number of content items that can be presented in a content item slot (or another portion of a resource) by selecting a set of content items that will provide a highest aggregate value, even if the number of content items in the set is fewer than the maximum number specified by the publisher. Thus, the publisher can accurately specify the maximum number of content items without sacrificing value. User satisfaction with a resource may be increased since the number of content items that provide the highest aggregate value may be fewer than the maximum number of content items that can be presented, thereby reducing resource clutter.

The details of one or more embodiments of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a block diagram of an example environment in which content is distributed to user devices.

FIG. 2 is a block diagram of an example data flow that illustrates an example content item selection process.

FIG. 3 is a flow chart of an example process for distributing content items.

FIG. 4 is a flow chart of an example process for determining a price to be charged for distribution of a content item.

FIG. 5 is block diagram of an example computer system.

Like reference numbers and designations in the various drawings indicate like elements.

### DETAILED DESCRIPTION

Content items are selected for presentation based on one or more measures of “sponsor value” associated with a given request or a value associated with a specific content item. For example, a sponsor value in general can be determined for a content sponsor that provides content items, and the sponsor value for that content sponsor can be associated with each content item provided by that content sponsor. Similarly, a different sponsor value can be determined for each content item request that is received (e.g., based on the bid submitted for use with respect to that content item request). Throughout this document, the term sponsor value is referred to as being associated with either the content sponsor or a content item provided by the content sponsor.

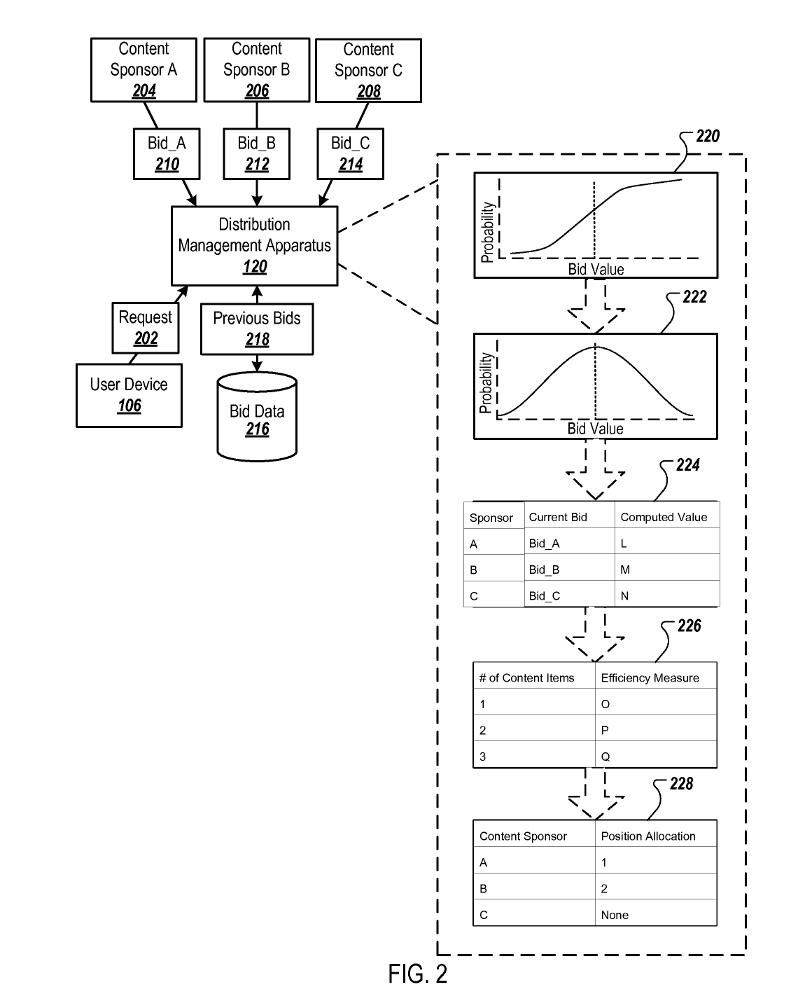

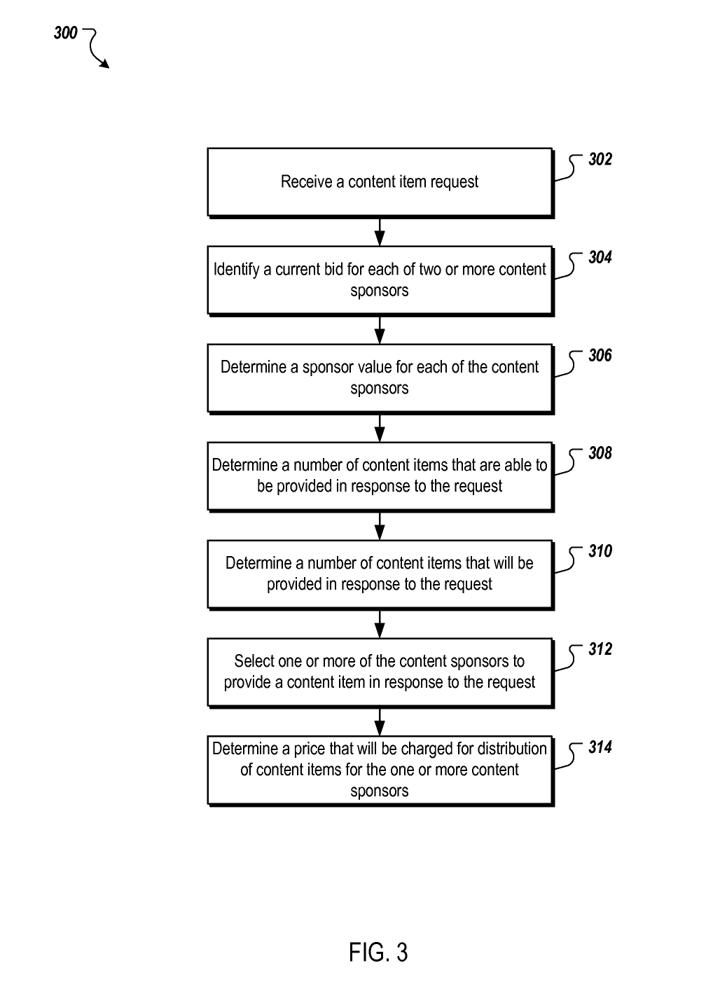

The sponsor value associated with a content item can be based on a function of the current bid associated with the content item (e.g., provided by the content sponsor) relative to a historical bid for the content item, or all historical bids provided by the content sponsor. For example, if the current bid is lower than a statistical measure of historical bids for the content item (or all bids provided by the content sponsor), the content item may have a lower sponsor value than if the current bid were higher than the statistical measure. Computation of the sponsor value is discussed in detail with reference to FIG. 2 and FIG. 3.

In some implementations, a set of one or more content items are selected based on the sponsor values. The number of content items selected in response to a received request can range from a single content item up to the maximum number of content items that can be presented in response to the request (e.g., as specified by the request). If fewer than the maximum number of content items are selected, the content items can be adjusted (e.g., resized) to fill the space available for presentation of content items provided in response to the request. The content item selection process can maximize an aggregate sponsor value of the content items provided in a configuration, which is referred to herein as the “efficiency” of the configuration. As used throughout this document, the term configuration can refer to a particular number of content items and/or an arrangement of content items responsive to a received request.

Once the content items have been selected, a price that will be charged for distribution of each content item is determined. The price for a particular content item can be determined, for example, based on “trigger prices” at which a presentation position of the particular content item would change if the bid associated with the content item were set to that price. For example, assume that there are two presentation positions available, and a particular content item is selected for presentation in a highest presentation position based on the current bid associated with the particular content item. In this example, a first trigger price will be the price at which the content item moves from the highest slot to the second slot, and a second trigger price will be the price at which the content item is no longer shown. Using the trigger prices and an estimated performance of the content item at each of the presentation positions, a performance weighted average of the trigger prices can be determined and used as the price charged for distribution of the particular content item. For example, the first trigger price can be weighted by the difference in performance between the first slot and the second slot, while the second trigger price can be weighted by the performance of the second slot.

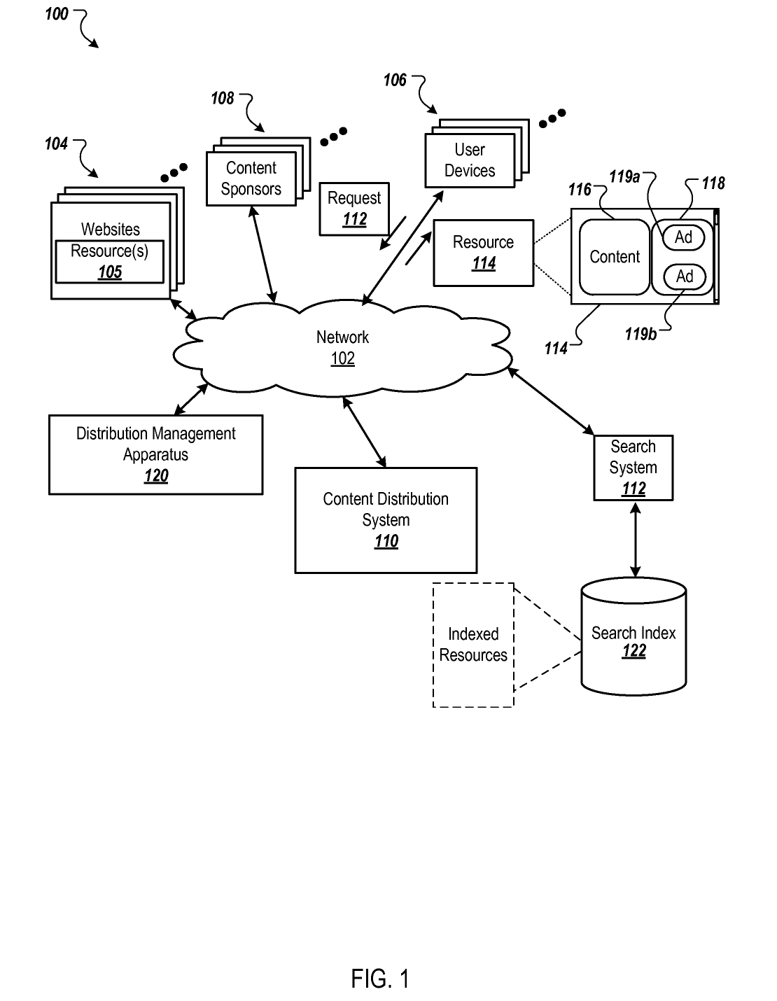

FIG. 1 is a block diagram of an example environment 100 in which content is distributed to user devices 106. The example environment 100 includes a network 102, such as a local area network (LAN), a wide area network (WAN), the Internet, or a combination thereof. The network 102 connects websites 104, user devices 106, content sponsors 108, and a content distribution system 110. The example environment 100 may include many different websites 104, user devices 106, and content sponsors 108.

A website 104 is one or more resources 105 associated with a domain name and hosted by one or more servers. An example website is a collection of web pages formatted in hypertext markup language (HTML) that can contain text, images, multimedia content, and programming elements, such as scripts. Each website 104 is maintained by a publisher, which is an entity that controls, manages and/or owns the website 104.

A resource 105 is any data that can be provided over the network 102. A resource 105 is identified by a resource address that is associated with the resource 105. Resources include HTML pages, word processing documents, and portable document format (PDF) documents, images, video, and feed sources, to name only a few. The resources can include content, such as words, phrases, images and sounds, that may include embedded information (such as meta-information in hyperlinks) and/or embedded instructions (such as scripts). Units of content that are presented in (or with) resources are referred to as content items, and an individual content item can be stored in a single file or set of files independent of the resource.

A user device 106 is an electronic device that is capable of requesting and receiving resources over the network 102. Example user devices 106 include personal computers, mobile communication devices, and other devices that can send and receive data over the network 102. A user device 106 typically includes a user application, such as a web browser, to facilitate the sending and receiving of data over the network 102.

A user device 106 can submit a resource request 112 that requests a resource 105 from a website 104. In turn, data representing the requested resource 114 can be provided to the user device 106 for presentation by the user device 106. The requested resource 114 can be, for example, a home page of a website 104, a web page from a social network, or another resource 105. The data representing the requested resource 114 can include data that cause presentation of resource content 116 at the user device 106. The data representing the requested resource 114 can also include data specifying a content item slot 118. A content item slot is a portion of the resource (e.g., a portion of a web page) or a portion of a user display (e.g., a presentation location of another window or in a slot of a web page) in which one or more content items, such as advertisements, can be presented. A content items slot 118 can also be referred to as an advertisement slot, but any type of content (e.g., content items other than advertisements) can be presented in the content item slot 118.

A single content item slot 118 may be configured to include one or more presentation positions 119a and 119b. Each presentation position can represent a portion of the content item slot 118 at which a content item can be presented. In some implementations, the number of presentation positions and/or the size of the presentation positions for a particular content item slot 118 may be determined based on the number, type, and/or value of content items that are available for presentation in the content item slot. For example, as described in detail below, a set of content items that are associated with respective highest values (e.g., among eligible content items) may be selected for presentation, and the number of presentation positions included in the content item slot 118 can be determined based on the number of content items that are included in the selected set of content items. A publisher can specify a maximum number of presentation positions that are to be included in a particular content item slot, and the selection of the set of content items can be constrained based on that maximum number.

To facilitate searching of resources, the environment 100 can include a search system 112 that identifies the resources by crawling and indexing the resources provided by the publishers on the websites 104. Data about the resources can be indexed based on the resource with which the data are associated. The indexed and, optionally, cached copies of the resources are stored in a search index 122. Data that are associated with a resource is data that represents content included in the resource and/or metadata for the resource.

User devices 106 can submit search queries to the search system 112 over the network 102. In response, the search system 112 accesses the search index 122 to identify resources that are relevant to the search query. The search system 112 identifies the resources in the form of search results and returns the search results to the user device in search results page. A search result is data generated by the search system 112 that identifies a resource that is responsive to a particular search query, and includes a link to the resource. An example search result can include a web page title, a snippet of text or a portion of an image extracted from the web page, and the URL of the web page. Like other resources, search results pages can include one or more content item slots 118 in which content items, such as advertisements, can be presented.

When a resource 105 is requested by a user device 106, execution of code associated with a content item slot 118 in the resource initiates a request for a content item to populate the slot. The request can include characteristics of the slots that are defined for the requested resource 114. For example, a reference (e.g., URL) to the requested resource 114 for which the content item slot 118 is defined, a size of the content item slot, a maximum number of presentation positions (or content items) that can be included in the content item slot 118, and/or media types that are eligible for presentation in the content item slot 118 can be provided to the content distribution system 110. Similarly, keywords associated with a requested resource (“resource keywords”) or entities that are referenced by the resource can also be provided to the content distribution system 110 to facilitate identification of content items that are relevant to the requested resource 114. The requests can also include other information, such as information that the user has provided, geographic information indicating a state or region from which the request was submitted, or other information that provides context for the environment in which the content item will be displayed (e.g., a type of device at which the content item will be displayed, such as a mobile device or tablet device).

The content items that are provided in response to a request (or another content item request) are selected based, in part, on distribution parameters associated with the content items. Distribution parameters are a set of criteria upon which distribution of content items are conditioned. In some implementations, the distribution criteria for a particular content item can include distribution keywords that must be matched (e.g., by resource keywords or search queries) in order for the content item to be eligible for presentation. The distribution criteria can also specify a bid and/or budget for distributing the particular content item. As described in more detail below, bids can be used to select a set of content items for presentation with a resource and/or to determine in which presentation position the content item(s) will be presented.

In some implementations, the content distribution system 110 determines a number of content items that will be provided in response to a particular content item request. For example, if the content distribution system 110 receives a request for one or more content items, the request may specify, or be associated with, a maximum number of content items that are able to be presented in a particular content item slot. In response to the content item request, the content distribution system 110 determines a number of content items, up to the maximum number, that will be provided in response to the request. For example, if the content item request specifies that up to five content items can be presented in a particular content item slot, the content distribution system can select between zero and five content items to be provided in response to the content item request.

In some implementations, the content items selected by the content distribution system 110 are sized for presentation based on the total number of content items that are being provided in response to the request. For example, assume that the dimensions of the content item slot remain constant irrespective of the number of content items that are presented in the content item slot. In this example, the selected content items can be sized so that the total dimensions of the combined set of content items correspond to (e.g., equal or be some specified amount less than) the dimensions of the content items slot, and the size of each content item can correspond to, or determine, a size of a presentation position for the content item. Thus, when a single content item is presented, that content item can have dimensions equal to the dimensions of the content item slot. Similarly, when two content items are presented, each of the content items can be sized to occupy one-half of the content item slot, and the dimensions of the content items can continue to decrease as the number of content items presented in the content item slot increases. Note that for purposes of example, the content items are each assumed to occupy an equal portion (when two or more are presented) of the content item slot, but the techniques described in this document can also be used when the various content items are of various sizes (e.g., where a highest ranked content item occupies more space than a lower ranked content item).

The performance of content items can vary based on the size of the content items and/or a number of content items that are presented. For example, if only a single content item is presented in a content item slot, that content item will be presented more prominently than if another content item were presented in the content item slot with that content item. Similarly, when a single content item is selected, that content item will be the only content item in the slot with which a user can interact. As more content items are presented in the content item slot, the user has the option of selecting any of the content items presented in the content item slot. Therefore, the expected performance of a particular content item when presented with one or more other content items may be lower than the expected performance when the particular content item is the only content item presented in the content item slot.

The performance of a content item can also vary based, in part, on a presentation position of the content item within the content item slot. For example, assume that two content items are presented in two presentation positions of a content item slot. In this example, users may more often interact with content items that are presented in a particular presentation position (e.g., a more prominent presentation position), such that the performance of (e.g., a number of clicks received by) content items presented in the particular presentation position may generally be higher than the performance of content items presented in the other presentation position.

In a particular example, the presentation position 119a may have a higher historical performance (e.g., historical click through rate) than the presentation position 119b. Therefore, the expected performance of a particular content item when selected for presentation in presentation position 119a may be higher than the expected performance of that content item when selected for presentation in presentation position 119b. Differences in expected performance of a content item based on the presentation position in which the content item is presented and/or a number of other content items that are being presented with the content item can be quantified using position factors, which are discussed in more detail below.

The variation in content item performance described above may lead a publisher to attempt to increase revenue by specifying a maximum number of content items that is lower than the actual maximum number of content items that can be presented in a content item slot, which is referred to as “artificially limiting” (i.e., the publisher artificially limits the maximum number of content items when in fact more can be presented). When a publisher artificially limits the maximum number of content items, it reduces the number of content items that will be presented in the content item slot, which can negatively impact the value of the content items slots to content sponsors, and may also negatively impact the revenue realized by the publisher.

The environment includes a distribution management apparatus 120 that allocates impressions to content items (or content sponsors) in a manner that encourages publishers to specify the actual maximum number of content items that can be presented in a content item slot, and also encourages a content sponsor to submit a bid representing the full value of an impression (or click) to that content sponsor. As described in more detail below, the distribution management apparatus 120 provides the above-referenced incentives by computing a sponsor value associated with content items that are eligible to be provided in response to a particular content item request, and using the sponsor values to select the number of content items that together provide a threshold sponsor value and/or a maximum sponsor value. In some implementations, the sponsor value for a particular content sponsor can generally be based, in part, on a bid that will be used for the current content item request relative to a range of previous bids that have been submitted by the content sponsor.

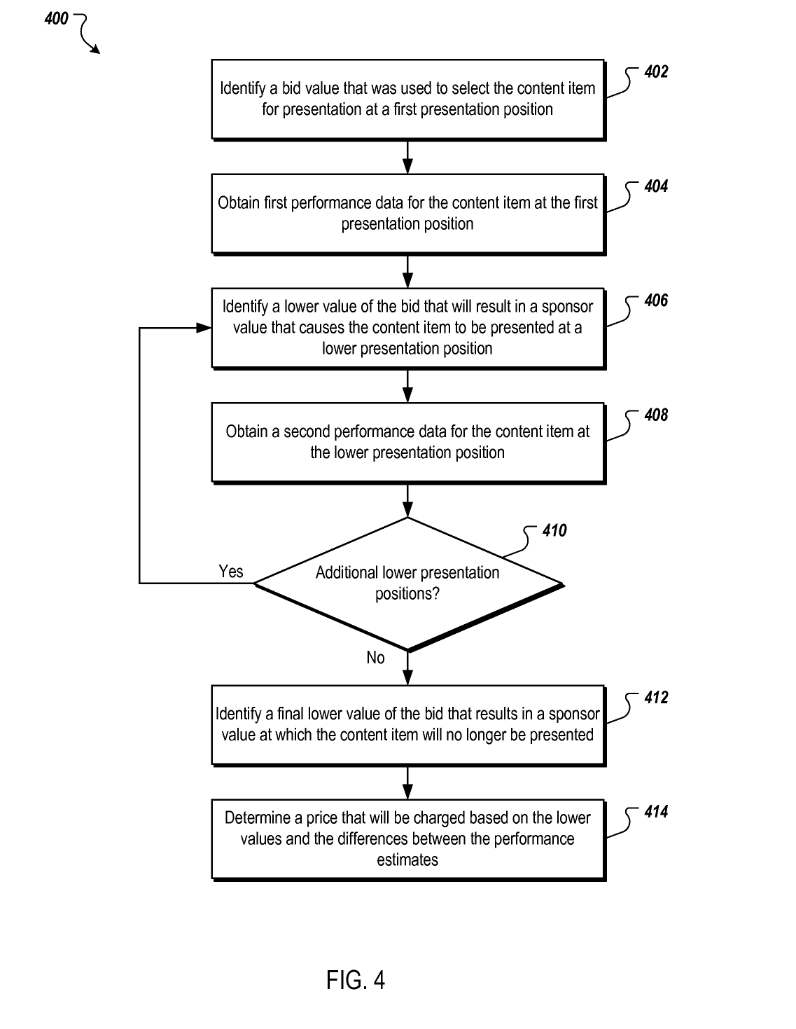

As described in detail with reference to FIG. 4, the distribution management apparatus 120 can determine a price for distribution of each content item that reduces, or eliminates, benefits that content sponsors may otherwise achieve by lowering their bid. For example, the price charged for distribution of a particular content item can be based on various bids that could be associated with the content sponsor (or content item), the configuration (e.g., number and/or presentation positions) of content items that would be distributed for each of the various bids, and/or an expected performance of the particular content item when distributed based on the various bids. A price determined based, in part, on these factors can generally result in a value to a content sponsor remaining fairly constant irrespective of the bid submitted, which provides an incentive for the content sponsor to submit a bid corresponding to a full value of an impression or click (e.g., based on a value of a conversion and/or conversion rate) to the content sponsor.

FIG. 2 is a block diagram of an example data flow 200 that illustrates an example content item selection process. The data flow 200 can begin with the distribution management apparatus 120 receiving a content item request 202 from a user device 106. As noted above, the content item request 202 can include information that facilitates selection of content items to be provided in response to the content item request 202. For example, the content item request 202 can include data (e.g., keywords or phrases) specifying one or more characteristics that are related to a resource with which the requested content items will be presented. The content item request can also specify a maximum number of content items that are able to be presented in presentation positions of a content item slot. For example, for the purposes of the following discussion, we can assume that the content item request 202 specifies that the content item slot in which the content items will be presented can include a maximum of three presentation positions. In this example, a maximum of three content items can be selected for presentation in response to the content item request 202.

Based at least in part on the information included in the content item request 202, the distribution management apparatus 120 identifies content sponsors that are eligible to provide a content item in response to the content item request 202. For example, the content distribution apparatus 120 can use keywords or other information related to the content item request (e.g., geographic information or time of day information) to identify eligible content items (e.g., content items having distribution parameters that are matched by the information included in the content item request 202) and/or the content sponsors that are associated with (e.g., provided) the eligible content items. In the present example, assume that Content Sponsor A 204, Content Sponsor B 206, and Content Sponsor C 208 are the three content sponsors that are associated with eligible content items for the content item request 202.

The distribution management apparatus 120 obtains, from each of the identified content sponsors 204, 206, and 208, bids that are associated with the respective eligible content items. In the present example, assume that Bid_A 210 is obtained from Content Sponsor A 204, Bid_B 212 is obtained from Content Sponsor B 206, and Bid_C 214 is obtained from Content Sponsor C 208. Note that, for purposes of example, Bid_A 210, Bid_B 212, and Bid_C 214 are described as being obtained from the respective content sponsors in response to receiving the content item request 202. In some implementations, the bids are received prior to receipt of the content item request 202, stored in a data store such as the bid data store 216, and obtained from the bid data store 216 in response to receiving the content item request 202.

The distribution management apparatus 120 obtains, from the bid data store 216, historical bid data for each of the content sponsors 204, 206, and 208. For example, as illustrated by FIG. 2, the historical bid data can include a set of (or distribution of) previous bids 218 that were submitted by each of the content sponsors 204, 206, and 208. The set of previous bids 218 that are obtained for each of the content sponsors can specify, for example, all previous bids that have been submitted by the content sponsor, all bids submitted by the content sponsor over a specified period (e.g., 1 week, 1 month, or 1 year), recent bids (e.g., a most recent or sequence of recent bids), and/or bids that the content sponsor has submitted for content item requests associated with a particular resource or publisher. Other bid segments can be defined/retrieved as required or desired.

In some implementations, the set of previous bids 218 that are obtained by the distribution management apparatus 120 in response to the content item request 202 can specify all bids that the content sponsors 210, 212, and 214 have submitted for content item requests associated with the specific publisher of the resource identified by the content item request 202. For example, assume that the content item request 202 specifies that the resource with which the requested content items will be presented is example.com. In this example, the distribution management apparatus 120 can request, from the bid data store 216, a set of previous bids 218 submitted by the content sponsors 204, 206, and 208 for previous content item requests for resources associated with the domain example.com and/or known related resources (e.g., resources in another domain that is registered to a same publisher).

Using the set of previous bids 218, the distribution management apparatus 120 determines a cumulative distribution function (“CDF”) 220 of the previous bids for each of the content sponsors 204, 206, and 208. In some implementations, the CDF 220 for a particular content sponsor describes a probability that a bid submitted by the particular content sponsor will be less than or equal to the various values included in the CDF 220. For example, for a particular bid X in the CDF 220, the CDF 220 provides a probability that a bid received from the content sponsor will be less than or equal to the particular bid X.

The distribution management apparatus 120 uses the CDF 220 for each of the content sponsors 204, 206, and 208, to determine a probability density function (“PDF”) 222 for each of the content sponsors 204, 206, and 208. In some implementations, the distribution management apparatus 120 determines the PDF 222 for a particular content sponsor based on a derivative of the CDF 220 for the particular content sponsor. For example, relationship 1 can be used to determine the PDF 222 based on a CDF 220.

$${PDF}_{i} ( b ) = \frac{d }{d b} {CDF}_{i} ( b ) \qquad ( 1 )$$

where,

PDFᵢ(b) is the probability density function for content sponsor i as a function of bid value (b); and

d/db(CDFᵢ(b)) is the derivative of the cumulative distribution function for content sponsor i as a function of bid value (b).

The distribution management apparatus 120 proceeds to determine a sponsor value for each of the content sponsors (e.g., a sponsor value associated with the content item provided by the content sponsor). In some implementations, the sponsor value of each content sponsor can be based on a function of the current bid submitted by the content sponsor, the CDF for the content sponsor, and the PDF for the content sponsor. For example, relationship (2) can be used to determine the sponsor value of a content sponsor.

$${SV}_{i} = {b}_{i} - \frac{1 - {CDF}_{i} ( {b}_{i} )}{{PDF}_{i} ( {b}_{i} )} \qquad ( 2 )$$

where,

SVᵢ is the sponsor value of content sponsor (i);

bᵢ is the bid value for content sponsor (i);

CDFᵢ(bᵢ) is the value provided by the cumulative distribution function for content sponsor i at the bid value of bᵢ; and

PDFᵢ(bᵢ) is the value provided by the probability density function for content sponsor i at the bid value of bᵢ.

In some implementations, the bid value bᵢ for content sponsor i is set equal to, or based on, the value of the current bid submitted by the content sponsor. For example, assume that Content Sponsor A 204 submitted a bid of $2.00 for use with respect to the content item request 202. In this example, the bid bᵢ can be set to $2.00.

In some implementations, the bid value bᵢ for content sponsor i is determined based on the current bid submitted by the content sponsor and one or more other values. For example, assume that the bid value bᵢ is determined, at least in part, on a product of a quality score for content sponsor i and the current bid submitted by content sponsor i. To illustrate, assume that Content Sponsor A 204 submitted a bid of $2.00 for use with respect to the content item request 202, and that the content sponsor A 204 has a quality score of 0.8 (e.g., on a scale of 0.0-1.0). In this example, the bid value bᵢ can be determined to be $1.60 (i.e., $2.00*0.8), which can be referred to as a quality-adjusted bid value.

For purposes of example, the discussion that follows simply refers to a bid value, which can either be the current bid submitted for use with respect to the content item request 202 or a quality-adjusted bid that is based on the current bid and quality score. Note that quality scores can be obtained from a data store, such as the bid data store 216 or received from another data processing apparatus and represent a relative measure of quality of content items provided by a particular content sponsor.

In some implementations, the relationship used to determine the sponsor value of a content sponsor can be based on the characteristics of relationship (2). For example, if relationship (2) is an increasing function of bᵢ, then the SVᵢ obtained from relationship (2) can be used as the sponsor value for the content sponsor. If relationship (2) is not an increasing function of bᵢ, other relationships can be used to determine the sponsor value of a content sponsor. For example, assume that relationship (2) is not an increasing function of bᵢ and that there does not exist some value SVᵢ>bᵢ for which relationship (3) is not met.

$${SV}_{i} - \frac{1 - {CDF}_{i} ( {SV}_{i} )}{{PDF}_{i} ( {SV}_{i} )} < {b}_{i} - \frac{1 - {CDF}_{i} ( {b}_{i} )}{{PDF}_{i} ( {b}_{i} )} \qquad ( 3 )$$

where,

SVᵢ is the value resulting from relationship (2) based on bᵢ;

CDFᵢ(SVᵢ) is the value provided by the cumulative distribution function for content sponsor (i) at the bid value of SVᵢ; and

PDFᵢ(SVᵢ) is the value provided by the probability density function for the content sponsor (i) at the bid value of SVᵢ.

In this example, relationship (4) can be used to determine the sponsor value for the content sponsor.

$${ASV}_{i} = {min}_{{SV}_{i} > {b}_{i}} ( {SV}_{i} - \frac{1 - {CDF}_{i} ( {SV}_{i} )}{{PDF}_{i} ( {SV}_{i} )} ) \qquad ( 4 )$$

where,

ASVᵢ is the alternative sponsor value for the content sponsor (i);

SVᵢ is the sponsor value provided by relationship (2) based on bᵢ;

CDFᵢ(SVᵢ) is the value provided by the cumulative distribution function for content sponsor (i) at the value SVᵢ;

PDFᵢ(SVᵢ) is the value provided by the probability density function for content sponsor (i) at the value SVᵢ.

Using the sponsor values, the distribution management apparatus 120 can create a content sponsor ranking 224 based on their respective sponsor values. For example, assume that a sponsor value of L was computed based on Bid_A 210, a sponsor value of M was computed based on Bid_B 212, and a sponsor value of N was computed based on Bid_C 214 and that L>M>N. In this example, Content Sponsor A 204 has a highest sponsor value and highest rank (e.g., rank of 1), Content Sponsor B 206 has a second highest sponsor value and second highest rank (e.g., rank of 2), and Content Sponsor C 208 has a third highest sponsor value and third highest rank (e.g., rank of 3), as illustrated by the content sponsor ranking 224.

The distribution management apparatus 120 uses the content sponsor ranking 224 and sponsor values to select the number of content items that will be provided in response to the request. In some implementations, the distribution management apparatus 120 selects between zero and the maximum number of content items specified by the content item request 202 to be provided in response to the content item request 202. The number of content items selected to be provided in response to the content item request 202 can be selected, for example, based on an efficiency measure for various configurations (e.g., different numbers) of content items.

As described in more detail below, the efficiency of a set of content items can generally represent a total value of the content items in the set, and the value of each content item can be based on the sponsor value associated with the content item (e.g., a sponsor value of a content sponsor that provides the content item) and a position factor for the position at which the content item will be presented in the configuration. As described in detail with reference to FIG. 3, because various factors, including the position factors of the various presentation positions, are used to determine the total value of a configuration, a configuration having a higher number of content items may actually have a lower efficiency than a configuration having a lower number of content items. Thus, a first configuration having fewer content items than a second configuration may have a higher efficiency than the second configuration.

The efficiency for a particular configuration of (e.g., number of) content items (or content sponsors) can be determined, for example, based on a function of (e.g., a sum of, weighted sum of, or another mathematical combination of) the sponsor values of content sponsors that are eligible to provide content items for presentation in the configuration. Generally, the content sponsors that are eligible to provide content items for presentation in the configuration will be those content sponsors associated with the highest sponsor values. For example, if a particular configuration includes two different content items, the efficiency of that configuration can be based on the two highest sponsor values for content sponsors that can provide a content item in response to the request. The computation of the efficiency measure is discussed in more detail with respect to FIG. 3. For purposes of the following example, assume that the efficiency of a configuration is determined based on the sum of the sponsor values of the content sponsors that can provide content items for presentation in the configuration.

To illustrate with respect to the example data flow 200, up to three content items can be presented in response to the content item request 200 since the content item request 202 specifies a maximum of three content items. Therefore, the distribution management apparatus 120 can determine that between zero and three content items can be provided in response to the content item request 202. In this example, as illustrated by table 226, a first efficiency measure (e.g., efficiency measure O) can be determined for a first configuration in which only one of the content items (e.g., a content item provided by Content Sponsor A 204, which is associated with a highest sponsor value) will be presented in response to the content item request 202, a second efficiency measure (e.g., efficiency measure P) can be determined for a second configuration in which two content items (e.g., content items provided by Content Sponsor A 204 and Content Sponsor B 206, which are associated with the two highest sponsor values) will be provided in response to the content item request 202, and a third efficiency measure (e.g., efficiency measure Q) can be determined for a third configuration in which three content items (e.g., content items provided by Content Sponsor A 204, Content Sponsor B 206, and Content Sponsor C 208, which are associated with the three highest sponsor values) will be provided in response to the content item request 202.

Assume for purposes of this example, that efficiency measure P is higher than both of the efficiency measure O and the efficiency measure Q. Since efficiency measure P corresponds to a configuration of two content items, the distribution management apparatus 120 can determine that two content items will be provided in response to the content item request 202. The distribution management apparatus 120 can also determine that the content sponsors associated with the two highest sponsor values (e.g., content items provided by Content Sponsor A 204 and Content Sponsor B 206) will be selected to provide content items in response to the content item request 202.

In some implementations, the presentation positions that are allocated to the content sponsors/content items can be selected based on the sponsor values of the content sponsors. For example, as illustrated by table 228, the content item provided by Content Sponsor A 204 can be presented in a first presentation position (e.g., highest position or most visually prominent position) since Content Sponsor A 204 is associated with a highest sponsor value, and the content item provided by Content Sponsor B 206 can be presented in the second presentation position (e.g., a second highest position or second most visually prominent position) since Content Sponsor B 206 is associated with a second highest sponsor value. The distribution management apparatus 120 can provide instructions that cause the selected content items to be provided for presentation at the user device 106 according to the selected allocation.

FIG. 3 is a flow chart of an example process 300 for distributing content items. The process 300 can be performed by one or more data processing apparatus, such as the distribution management apparatus 120 or the content distribution system 110 of FIG. 1. Operations of the process 300 can be implemented by execution of instructions stored on a non-transitory computer readable medium and that cause one or more data processing apparatus to perform operations of the process 300.

A content item request is received (302). In some implementations, the content item request is received from a user device that is rendering a resource. For example, as described above, code included in the resource being rendered by the user device can cause the user device to submit a content item request. The content item request can include information that can be used to select one or more content items that will be provided in response to the content item request. For example, the content item request can include data specifying one or more topics related to the resource and/or other contextual data that can be used by a content item selection process.

The content item request can also specify a maximum number of content items that can be provided in response to the request. For example, if up to three content items can be presented in a content item slot corresponding to the request, then the content item request can specify a maximum of three content items.

A current bid is identified for each of two or more content sponsors (304). In some implementations, the current bid is requested from and/or received from each of the content sponsors following receipt of the content item request. In some implementations, the bids are submitted by the content sponsors prior to receipt of the content item request, and the bids that will be used to select content items are identified upon receipt of the content item request. Each bid specifies a maximum amount that the content sponsor is willing to pay for distribution of a content item. The bid can be expressed on a per one thousand impressions (“CPM”) basis or on a cost per click (“CPC”) basis. If the bid is expressed on a CPC basis, the bid can be converted to an estimated CPM (“eCPM”) bid, which specifies an estimated amount that will be paid for one thousand impressions of the content item, and the eCPM bid can be used for subsequent determinations that utilize a bid value.

The eCPM of a CPC bid can be determined, for example, based on a number of clicks that the content item has received, the CPC bid, and a number of impressions that the content item has received. For example, the eCPM for a content item can be determined according to relationship (5).

$$eCPM = \frac{CPC * Number of Clicks}{Number of Impressions} \qquad ( 5 )$$

A sponsor value is determined for each of the two or more content sponsors (306). In some implementations, the sponsor value is determined based on the current bid (e.g., eCPM bid) received from the content sponsor and previous bids that were previously used during a content item selection process. For example, as described above with reference to FIG. 2, historical bid values can be obtained for each of the content sponsors and each of the historical bids can correspond to a bid that was submitted by the content sponsor for use with respect to previous content item requests. The historical bids can define or be stored in the form of a bid distribution for the content sponsor. For example, the distribution of previously bids that were previously received from a particular content sponsor can be obtained from a database of historical bids.

As described above with respect to FIG. 2, the historical bids can be used to determine a cumulative distribution function, which can be used to determine a probability density function of the bids. In turn, a function of the current bid, the cumulative distribution function, and/or the probability density function can be used to determine the sponsor value for each of the content sponsors. For example, one or more of relationships (2) or (4) discussed above can be used to determine the sponsor values for the content sponsors.

In some implementations, a separate cumulative distribution function and probability density function is determined for each content sponsor. For example, the cumulative distribution function and corresponding probability density function can be determined for a particular content sponsor based on the bids that were submitted by that content sponsor, independent of the bids that were submitted by other content sponsors.

Additionally, or alternatively, a particular content sponsor can have a separate cumulative distribution function and corresponding probability density function for each different publisher. For example, a particular content sponsor can have a first CDF and corresponding PDF for resources provided by a first particular publisher, and have a second different CDF and PDF for resources provided by a second different publisher. The first CDF and corresponding PDF can be determined, for example, based on the bids that the particular content sponsor provided for content requests associated with the resources from the first particular publisher (e.g., independent of bids submitted by other content sponsors or other bids submitted by the particular content sponsor for content requests associated with resource from other publishers). In other words, when the CDF and PDF for a particular content sponsor are determined on a per-publisher basis, the CDF can be determined based on a proper subset (fewer than all) of the previous bids, and the proper subset can include only those bids that the content sponsor submitted with respect to content item requests requesting content items for presentation with resources provided by the particular publisher.

In some implementations, multiple different content sponsors share a same CDF and PDF. For example, instead of (or in addition to) determining a different CDF for each different content sponsor-publisher pair, with respect to a single publisher, a same CDF can be used by all (or a portion of) the content sponsors. In some implementations, the single CDF that is used for of the multiple different content sponsors can be determined based on all of (or a portion of the bids) that were received from any of the multiple different content sponsors and used as part of a content item selection process for a content item request associated with resources provided by that single publisher. In some implementations, the CDF and PDF will not vary on a per-content sponsor basis, but will vary on a per-publisher basis.

In some implementations, a single CDF is determined for each content sponsor, and this single CDF will not vary on a per-publisher basis. In some implementations, each content sponsor's CDF will be determined independent of the bids provided by other content sponsors and independent of the CDFs determined for other content sponsors. In some implementations, the single CDF determined for a particular content sponsor can be based on any or all bids received from that particular content sponsor, but generally may not consider bids submitted by other content sponsors. Thus, this CDF for the particular content sponsor can be publisher independent and consider bids that the particular content sponsor submitted for content item requests associated with resources provided by multiple different publishers.

A number of content items that are able to be provided in response to the request is determined (308). As discussed above, the number of content items that are able to be provided in response to the request can be referred to as a maximum number of content items, and can be specified by the publisher of the resource with which the selected content items will be presented. The maximum number can be specified in the content item request or can be obtained from a data store storing the maximum number for various publishers.

A number of content items that will be provided in response to the request is determined (310). In some implementations, the number of content items that will be provided is determined based on an aggregate (e.g., total) sponsor value of content sponsors that would be selected to provide content items for various content item configurations. The value of a particular configuration is referred to as an efficiency of that particular configuration. In some implementations, the configuration (e.g., the number of content items) that has a highest efficiency is used to determine the number of content items that will be provided in response to the content item request.

For example, for each candidate configuration of content items, the efficiency of the candidate configuration can be a sum of the sponsor values of the content sponsors that would provide content items to be included the configuration. The candidate configurations can include configurations that include one to “N” content items, where “N” is an integer corresponding to a maximum number of content items that can be presented in the content item slot, and each different number of content items can constitute a different configuration.

In some implementations, the threshold efficiency is specified to be a maximum efficiency that is provided by any candidate configurations. For example, assume that three different candidate configurations of content items are available (e.g., a one content item configuration, a two content item configuration, and a three content item configuration). In this example, the threshold efficiency can be provided by the configuration that provides the highest efficiency. Note that the threshold efficiency can also be specified as an absolute efficiency value or a relative efficiency value (e.g., relative to an efficiency provided by one or more other configurations).

In some implementations, the configuration that provides the threshold efficiency is identified from all candidate configurations that can be created using up to the maximum number of content items that can be provided in response to the content item request. For example, the maximum number of content items that can be provided can be identified from the content item request, and the total number of content sponsors that are eligible to provide a content item in response to the content item request.

The candidate configurations can be determined based, at least in part, on the maximum number of content items that can be provided in response to the content item request. For example, assume that up to three content items can be presented in a content item slot, and that only two content items are available to be provided in response to the content item request. Further assume that each configuration differs in the number of content items that are presented. In this example, two content items can be provided in response to the request, and there can be two different candidate configurations (e.g., a content item provided by a content sponsor having a highest ranking can be presented alone in one candidate configuration and both available content items can be presented in another candidate configuration).

Once the candidate configurations have been identified, a position adjusted sponsor value can be determined for each of the content sponsors in the candidate configuration. The position adjusted sponsor value can be based, for example, on a product of (or another mathematical combination of) the sponsor value of the content sponsor and a position factor corresponding to the presentation position of the content item in the candidate configuration.

A position factor can represent a position-specific performance associated with a presentation position. For example, the position factor for a particular presentation position in a content item slot can represent the performance of content items presented in that particular presentation position relative to a baseline performance of content items. The baseline performance can be, for example, an average performance of content items presented in a reference presentation position (e.g., a highest performing or lowest performing presentation position). For example, assume that two presentation positions are available in a particular content item slot, and that the average click through rate for content items presented in a first of the presentation positions is 0.20, and that the average click through rate for content items presented in the second presentation position is 0.10. In this example, the baseline performance can be set to 0.20, and the position factor for the second presentation position can be 0.5 (e.g., 0.10/0.20). In some implementations, the baseline performance can be based on an average performance of all content items presented in the content item slot (e.g., irrespective of presentation position).

Using the baseline performance, the position factor for a particular presentation position can be determined according to relationship (6).

PF(i,j)=CI_Perf(i,j)/CI_Perf(bl) (6)

where,

PF(i,j) is the performance factor for presentation position i when j content items are presented in the content item slot;

CI_Perf(i,j) is the performance of content items presented in position i when j content items are presented in the content item slot; and

CI_Perf(bl) is the baseline performance.

A single presentation position may be associated with multiple different performance factors. For example, performance factors can be determined on a per-content sponsor basis, and used to adjust sponsor value associated with each respective content sponsor. Also, a particular presentation position may have a first performance factor when two content items are presented in the content item slot, and have a second different performance factor when three content items are presented in the content item slot.

For example, assume that the performance of content items presented in a second presentation position (e.g., a second highest performing presentation position) of a content item slot has a value of 0.4 (e.g., a click through rate of 0.4) when only two content items are presented in the content item slot, and has a value of 0.1 (e.g., a click through rate of 0.1) when three content items are presented in the content item slot. In this example, the presenting three content items in the content item slot, instead of presenting two content items, reduces the performance of the second content item slot. Thus, the performance factor for the second presentation position in a two content item configuration will be higher than the performance factor for the second presentation position in a three content item configuration.

In this example, when only a single content item is presented in the content item slot, the performance factor for the single presentation position may generally be higher than the performance factor for a highest presentation position when two or more content items are presented in the content item slot, since presentation of the additional content items will reduce the prominence of the highest presentation position.

As discussed above, position factors can be used to determine position adjusted sponsor values. The position adjusted sponsor values can be used to determine an aggregate sponsor value for each of the candidate configurations, and the candidate configuration having the highest aggregate sponsor value can be used to determine a number of content items that will be provided in response to the content item request.

For purposes of example, assume the content item request specifies that up to three content items can be presented in the content item slot for which content items are being requested. In this example, the candidate configurations can include a first configuration in which only a single content item is presented, a second configuration in which two content items are presented, and a third configuration in which three content items are presented in the content item slot. Further assume that Table 1 (below) lists the three content sponsors having the three highest sponsor values with respect to the current content item request.

TABLE 1

| Content Sponsor | Sponsor value |
|---|---|
| 1 | 2.00 |
| 2 | 1.75 |
| 3 | 1.25 |

In this example, the efficiency of each candidate configuration can be determined as provided in Table 2, where SVᵢ*PFᵢ is the position adjusted sponsor value for content sponsor (i).

TABLE 2

| Number of Presentation Positions in Configuration (j) | Content Sponsor (CS) Assigned to Each Presentation Position (i) | Position Factors (PF) | $\begin{matrix}Configuration Efficiency \\ Eff = {\sum }_{i = 1}^{j} {SV}_{i} * {PF}_{i , j}\end{matrix}$ |
|---|---|---|---|
| 1 | Pos. 1 = CS 1 | Pos. 1 = 1.5 | 2.0*1.5 = 3.0 |
| 2 | Pos. 1 = CS 1 | Pos. 1 = 1.1 | (2.0*1.1) + (1.75*0.7) = 3.425 |
| | Pos. 2 = CS 2 | Pos. 2 = 0.7 | |
| 3 | Pos. 1 = CS 1 | Pos. 1 = 0.6 | (2.0*0.6) + (1.75*0.2) + (1.25*0.2) = 1.8 |
| | Pos. 2 = CS 2 | Pos. 2 = 0.2 | |
| | Pos. 3 = CS 3 | Pos. 3 = 0.2 | |

As presented in Table 2, the configuration in which content sponsor 1 is assigned the first presentation position (Pos. 1) and content sponsor 2 is assigned the second presentation position (Pos. 2) is associated with a highest efficiency. Therefore, in this example, two content items will be selected for presentation in response to the content item request.

One or more of the content sponsors are selected to provide a content item in response to the content item request (312). In some implementations, the content sponsors associated with the highest sponsor values are selected to provide a content item in response to the request. As illustrated above, content sponsor 1 and content sponsor 2 are associated with the two highest sponsor values, and therefore, will be selected to provide the two content items in response to the content item request. In some implementations, the presentation positions that are assigned to each of the content sponsors can be based, at least in part, on the sponsor values of the content sponsors. For example, a content sponsor having a highest sponsor value can be assigned to a highest performing presentation position, and each next highest performing presentation position can be assigned to the content sponsor with the next highest sponsor value.

A price that will be charged for distribution of the one or more content items for the one or more content sponsors is determined (314). Generally, as described in more detail with reference to FIG. 4, the price paid by a particular content sponsor can be determined based on trigger prices at which the selected configuration of content items would change if the particular content sponsor lowered its bid to that price. For purposes of illustration, if there are m trigger prices that would cause a configuration change, (e.g., p_{i,1}, . . . , p_{i,m}, where p_{i,1}>p_{i,2}> . . . >p_{i,m}), then these m trigger prices can be utilized to determine the price that the particular content sponsor will pay for distribution of their content items. For example, the price that the content sponsor will pay can be a performance weighted average of these m trigger prices. In a particular example, the price can be determined using relationship (7).

$${P}_{cpc} = \frac{1}{{q}_{i} {x}_{i , 1}} {\sum }_{j = 1}^{m} ( {x}_{i , j} - {x}_{i , j + 1} ) {p}_{i , j} \qquad ( 7 )$$

where,

P_{cpc} is the price per click that the content sponsor (i) will be charged;

x_{i,1} is the position factor when the bid for content sponsor (i) is greater than p_{i,1};

x_{i,j} is the position factor when the bid for content sponsor (i) is between p_{i,j-1} and p_{i,j};

x_{i,m+1}=0 and

qᵢ is the quality score for content sponsor (i).

FIG. 4 is a flow chart of an example process 400 for determining a price to be charged for distribution of a content item. The process 400 can be performed by one or more data processing apparatus, such as the distribution management apparatus 120 and/or the content distribution system 110 of FIG. 1. Operations of the process 400 can be implemented by execution of instructions stored on a non-transitory computer readable medium and that cause one or more data processing apparatus to perform operations of the process 400.

A bid that was used to select the content item for presentation at a first presentation position is identified (402). The first presentation position can be one of multiple different presentation positions that are available in a content item slot. In some implementations, the bid that was used to select the content item for presentation at the first presentation position is a first value, or a quality-adjusted value, corresponding to the bid submitted by the content sponsor associated with the content item. For example, the bid used to select the content item can be a maximum bid submitted (or selected) by the content sponsor, or a value resulting from a product of the maximum bid and a quality measure (e.g., quality score) corresponding to the content sponsor.

For purposes of illustration, assume that Content Sponsor A submitted a bid having a value of $2.00, and Content Sponsor B submitted a bid of $1.50. Further assume, for purposes of this example, that there are two available presentation positions, and that these bids result in Content Sponsor A and Content Sponsor B being assigned to the two presentation positions (e.g., with Content Sponsor A being assigned a highest performing presentation position for having a higher sponsor value). Thus, in this example, the bid of $2.00 can be identified as the bid that was used to select a content item from Content Sponsor A for presentation in the highest performing presentation position, and the bid of $1.50 can be identified as the bid that was used to select a content item from Content Sponsor B in the second highest performing presentation position.

First performance data for the content item at the first presentation position is obtained (404). In some implementations, the first performance data specifies a measure of user interactions that the content item is expected to receive (referred to as an “expected performance” or “estimated performance”) when presented at the first presentation position. For example, the first performance data can include a total number of clicks (or other user interactions) that the content item is expected to receive over a specified period of time (e.g., when presented at the first presentation position), a click-through rate (or interaction rate) that the content item is expected to experience when presented at the first presentation position, or another measure of performance. The first performance data can be obtained from a data store storing the performance data.

In some implementations, the expected performance specified by the first performance data is determined based on historical performance of the content item, historical performance of any or all content items presented at the first presentation position, and/or a position factor for the first presentation position. For example, the expected performance can be based on a number of user interactions that the content item received when previously presented at the first presentation position (e.g., over a specified period or number of impressions), a click-through rate of the content item when presented at the first presentation position, and/or a click-through rate of all content items presented in the first presentation position. For purposes of example, assume that the first performance data for the content item provided by Content Sponsor A specifies that the content item is expected to receive 3 clicks over a set of 100 impressions.

A lower value of the bid that will result in a sponsor value that causes the content item being presented at a different presentation position is identified (406). In some implementations, the lower value is a value at which the content item will be presented in a lower performing presentation position. The lower value can be determined, for example, by lowering the value of the bid associated with the content item until the sponsor value of the content item falls below the next highest sponsor value associated with another content item that is available for presentation. The sponsor values associated with the content item and the other content item can be determined based on bid values, cumulative distribution functions, and probability density functions, as described above.

Continuing with the example above, the lower value for the bid associated with Content Sponsor A can be determined by iteratively lowering the value of the bid associated with Content Sponsor A until Content Sponsor A's sponsor value meets, or is lower than, the sponsor value of Content Sponsor B (e.g., the sponsor value that is computed for Content Sponsor B based on the bid value of $1.50). Assume for purposes of this example that the bid value at which the sponsor value of Content Sponsor A falls below the sponsor value of Content Sponsor B is at a value of $1.60. Thus, in this example, the identified lower value of the bid can be $1.60.

Second performance data for the content item at the second presentation position is obtained (408). The second performance data for the content item at the second presentation position can specify an expected performance of the content item when presented at the second presentation position. The second performance data can be obtained and/or determined in a manner similar to that described above with respect to obtaining the first performance data (404). For example, the second performance data can be obtained from a data store storing the second performance data. The expected performance specified by the second performance data can be determined based, at least in part on the historical performance of the content item, the historical performance of the content item and/or other content items when presented at the second presentation position, and/or based on a position factor for the second presentation position.

Continuing with the example above, assume that the second performance data for the content item provided by Content Sponsor A specifies that the content item is expected to receive 1 click over a set of 100 impressions when presented at the second presentation position.

A determination is made whether there are additional lower presentation positions at which the content item could be presented (410). In some implementations, the determination of whether there are additional lower presentation positions can be made by comparing the current number of presentation positions to the maximum number of presentation positions for the content item slot (e.g., as indicated by a content item request). If the current number of presentation positions is less than the maximum number of presentation positions, then there may be additional lower presentation positions in which the content item can be presented.

In some implementations, the determination of whether there are additional lower presentation positions can also be based on an evaluation of the number of content items that would be selected for presentation as the bid for the content item is lowered. For example, as discussed above, the number of content items selected for presentation is based on the efficiency associated with the various numbers of content items that can be selected. Thus, even if the maximum number of presentation positions is higher than the current number of presentation positions, an additional lower presentation position may not be available if the efficiency associated with presentation of a content item in that additional lower presentation position is less than the efficiency associated with a configuration that does not include presentation of a content item in the lower presentation position.

If additional lower presentation positions are available, an additional lower value is identified (406), and performance data associated with the additional lower presentation position is obtained. The determination of whether there are additional lower presentation positions, and the obtaining of performance data can continue until there are no lower presentation positions to evaluate.

If there are no additional lower presentation positions to evaluate, a final lower value that results in a sponsor value at which the content item will no longer be presented is identified (412). The final lower value can be identified in a manner similar to that described above with respect to operation (406). For example, the lower value at which the content item will no longer be associated with one of the top X sponsor values (where X is the number of presentation positions that are being used to present content items), and therefore not selected for presentation, can be identified. Since the final lower value can generally be the value at which the content item will no longer be selected for presentation, the performance data corresponding to the final lower value can specify an expected performance of zero.

A price that will be charged is determined based on the lower values and the differences between the expected performance specified by the performance data (414). For example, the price that will be charged can be a performance weighted average of the lower prices (e.g., lower prices identified at operation 406 and the final lower price identified at operation 412). The weight of each lower price can be a difference between the estimated performance of the content item at the lower presentation position corresponding to the lower price and the estimated performance of the content item at the next highest presentation position.

For example, assume that Table 3 (below) specifies various bid values at which the selection content item configuration will change, the presentation position that will be occupied by the content item at that bid value, and the estimated performance (e.g., number of clicks) for a content item at various presentation positions.

TABLE 3

| Bid | Presentation | Number |
|---|---|---|
| Value | Position | of Clicks |
| 2.00 (current bid) | 1 | 3 |
| 1.60 | 2 | 1 |
| 1.00 | None | 0 |

Price = ($1.60*(3 − 1) + 1.00*(1 − 0))/3 = $1.40

In this example, the performance weighted average of the bid values that will cause a configuration change (e.g., $1.60 and $1.00) results in a price of $1.40 cost per click. Thus, the content sponsor in this example can be charged a price of $1.40 CPC for presentation in the first presentation position.

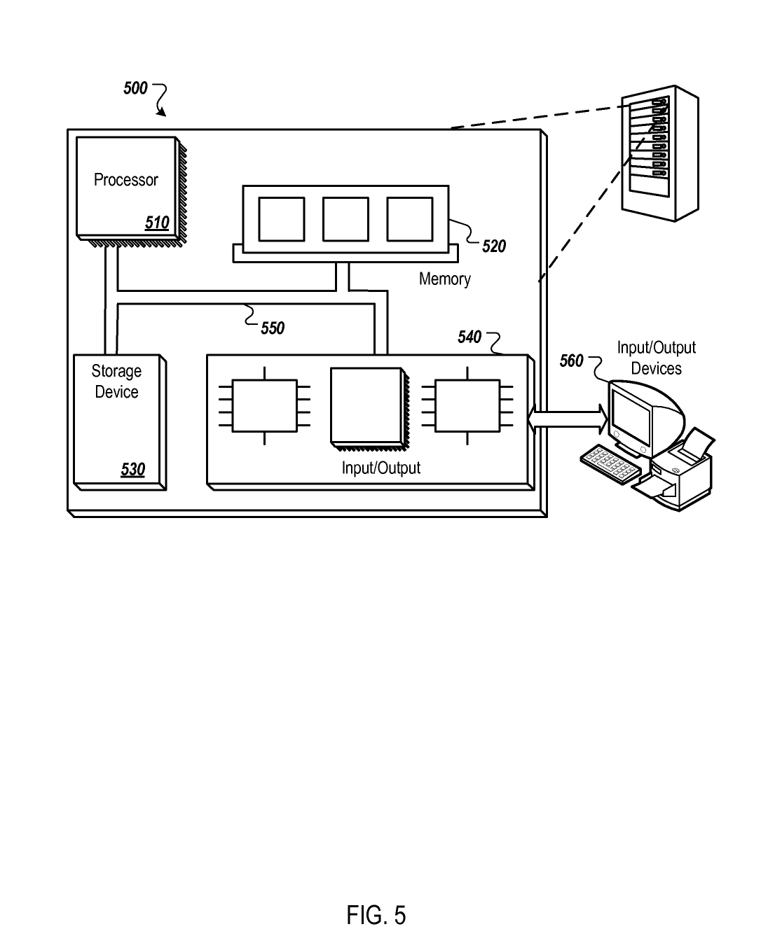

FIG. 5 is a block diagram of an example computer system 500 that can be used to perform operations described above. The system 500 includes a processor 510, a memory 520, a storage device 530, and an input/output device 540. Each of the components 510, 520, 530, and 540 can be interconnected, for example, using a system bus 550. The processor 510 is capable of processing instructions for execution within the system 500. In one implementation, the processor 510 is a single-threaded processor. In another implementation, the processor 510 is a multi-threaded processor. The processor 510 is capable of processing instructions stored in the memory 520 or on the storage device 530.

The memory 520 stores information within the system 500. In one implementation, the memory 520 is a computer-readable medium. In one implementation, the memory 520 is a volatile memory unit. In another implementation, the memory 520 is a non-volatile memory unit.

The storage device 530 is capable of providing mass storage for the system 500. In one implementation, the storage device 530 is a computer-readable medium. In various different implementations, the storage device 530 can include, for example, a hard disk device, an optical disk device, a storage device that is shared over a network by multiple computing devices (e.g., a cloud storage device), or some other large capacity storage device.

The input/output device 540 provides input/output operations for the system 500. In one implementation, the input/output device 540 can include one or more of a network interface devices, e.g., an Ethernet card, a serial communication device, e.g., and RS-232 port, and/or a wireless interface device, e.g., and 802.11 card. In another implementation, the input/output device can include driver devices configured to receive input data and send output data to other input/output devices, e.g., keyboard, printer and display devices 560. Other implementations, however, can also be used, such as mobile computing devices, mobile communication devices, set-top box television client devices, etc.

Although an example processing system has been described in FIG. 5, implementations of the subject matter and the functional operations described in this specification can be implemented in other types of digital electronic circuitry, or in computer software, firmware, or hardware, including the structures disclosed in this specification and their structural equivalents, or in combinations of one or more of them.

Embodiments of the subject matter and the operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer programs, i.e., one or more modules of computer program instructions, encoded on computer storage medium for execution by, or to control the operation of, data processing apparatus. Alternatively or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate physical components or media (e.g., multiple CDs, disks, or other storage devices).

The operations described in this specification can be implemented as operations performed by a data processing apparatus on data stored on one or more computer-readable storage devices or received from other sources.

The term “data processing apparatus” encompasses all kinds of apparatus, devices, and machines for processing data, including by way of example a programmable processor, a computer, a system on a chip, or multiple ones, or combinations, of the foregoing The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some embodiments, a server transmits data (e.g., an HTML page) to a client device (e.g., for purposes of displaying data to and receiving user input from a user interacting with the client device). Data generated at the client device (e.g., a result of the user interaction) can be received from the client device at the server.

While this specification contains many specific implementation details, these should not be construed as limitations on the scope of any inventions or of what may be claimed, but rather as descriptions of features specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

What is claimed is:

1. A method performed by data processing apparatus, the method comprising:
identifying, for a content item that was selected for presentation in a first presentation position of a resource that includes at least two presentation positions, a sponsor value that was used to select the content item for presentation in the first presentation position, the sponsor value being a value determined based on a current bid associated with the content item and one or more previous bids that were previously associated with the content item;
identifying, by one or more data processing apparatus, a first lower value of the sponsor value that will result in the content item being presented at a different presentation position of the resource;
obtaining, by one or more data processing apparatus, a first estimated performance for the content item at the first presentation position and a second estimated performance for the content item at the different presentation position; and
determining, by one or more data processing apparatus, a price to be charged for presentation of the content item at the first presentation position based on a first bid value that results in the sponsor value meeting the first lower value and a difference between the first estimated performance and the second estimated performance.

2. The method of claim 1, comprising:
determining that a lower presentation position is available;
determining a second lower value of the sponsor value that will result in the content item being presented in the lower presentation position; and
determining a third estimated performance of the content item at the lower presentation position, wherein:
determining a price that will be charged comprises determining a performance weighted average of the first bid value and a second bid value that results in the sponsor value meeting the second lower value, a first weight assigned to the first bid value being based on a difference between the first estimated performance and the second estimated performance, a second weight assigned to the second bid value being based on a difference between the second estimated performance and the third estimated performance.

3. The method of claim 1, wherein identifying a first lower value comprises identifying a sponsor value at which a first sponsor value of a particular content sponsor associated with the content item falls below a second sponsor value of another content item sponsor that has been selected to provide a content item in one of the at least two presentation positions.

4. The method of claim 3, comprising determining the second sponsor value based on a current bid associated with the other content sponsor, a cumulative distribution function associated with the other content sponsor, and a probability density function associated with the other content sponsor.

5. The method of claim 1, comprising identifying a bid value at which the sponsor value meets the first lower value, the identification comprising:
determining, for the particular content sponsor, a cumulative distribution function based on bids that have been previously received from the particular content sponsor;
determining, for the particular content sponsor, a probability density function, based on the cumulative distribution function; and
determining a bid value at which an output of a function of the bid value, the cumulative distribution function, and the probability density function meet the first lower value.

6. The method of claim 1, comprising identifying a final lower value at which the content item will no longer be presented, wherein determining a price that will be charged comprises determining the price based on the bid that provides the first lower value, the final lower value, and the second estimated performance.

7. A system comprising:
a data store storing current bids for a plurality of content sponsors; and
one or more data processing apparatus that interact with the data store and execute instructions that cause the one or more data processing apparatus to perform operations comprising:
identifying, for a content item that was selected for presentation in a first presentation position of a resource that includes at least two presentation positions, a sponsor value that was used to select the content item for presentation in the first presentation position, the sponsor value being a value determined based on a current bid associated with the content item and one or more previous bids that were previously associated with the content item;
identifying a first lower value of the sponsor value that will result in the content item being presented at a different presentation position of the resource;
obtaining a first estimated performance for the content item at the first presentation position and a second estimated performance for the content item at the different presentation position; and
determining a price to be charged for presentation of the content item at the first presentation position based on a first bid value that results in the sponsor value meeting the first lower value and a difference between the first estimated performance and the second estimated performance.

8. The system of claim 7, wherein the instructions cause the one or more computers to perform operations comprising:
determining that a lower presentation position is available;
determining a second lower value of the sponsor value that will result in the content item being presented in the lower presentation position; and
determining a third estimated performance of the content item at the lower presentation position, wherein:
determining a price that will be charged comprises determining a performance weighted average of the first bid value and a second bid value that results in the sponsor value meeting the second lower value, a first weight assigned to the first bid value being based on a difference between the first estimated performance and the second estimated performance, a second weight assigned to the second bid value being based on a difference between the second estimated performance and the third estimated performance.

9. The system of claim 7, wherein identifying a first lower value comprises identifying a sponsor value at which a first sponsor value of a particular content sponsor associated with the content item falls below a second sponsor value of another content item sponsor that has been selected to provide a content item in one of the at least two presentation positions.

10. The system of claim 9, wherein the instructions cause the one or more computers to perform operations comprising determining the second sponsor value based on a current bid associated with the other content sponsor, a cumulative distribution function associated with the other content sponsor, and a probability density function associated with the other content sponsor.

11. The system of claim 7, wherein the instructions cause the one or more computers to perform operations comprising identifying a bid value at which the sponsor value meets the first lower value, the identification comprising:
determining, for the particular content sponsor, a cumulative distribution function based on bids that have been previously received from the particular content sponsor;
determining, for the particular content sponsor, a probability density function, based on the cumulative distribution function; and
determining a bid value at which an output of a function of the bid value, the cumulative distribution function, and the probability density function meet the first lower value.

12. The system of claim 7, wherein the instructions cause the one or more computers to perform operations comprising identifying a final lower value at which the content item will no longer be presented, wherein determining a price that will be charged comprises determining the price based on the bid that provides the first lower value, the final lower value, and the second estimated performance.

13. A non-transitory computer readable medium storing instructions that upon execution by one or more data processing apparatus cause the one or more data processing apparatus to perform operations comprising:
identifying, for a content item that was selected for presentation in a first presentation position of a resource that includes at least two presentation positions, a sponsor value that was used to select the content item for presentation in the first presentation position, the sponsor value being a value determined based on a current bid associated with the content item and one or more previous bids that were previously associated with the content item;
identifying a first lower value of the sponsor value that will result in the content item being presented at a different presentation position of the resource;
obtaining a first estimated performance for the content item at the first presentation position and a second estimated performance for the content item at the different presentation position; and
determining a price to be charged for presentation of the content item at the first presentation position based on a first bid value that results in the sponsor value meeting the first lower value and a difference between the first estimated performance and the second estimated performance.

14. The computer readable medium of claim 13, wherein the instructions cause the one or more computers to perform operations comprising:
determining that a lower presentation position is available;
determining a second lower value of the sponsor value that will result in the content item being presented in the lower presentation position; and
determining a third estimated performance of the content item at the lower presentation position, wherein:
determining a price that will be charged comprises determining a performance weighted average of the first bid value and a second bid value that results in the sponsor value meeting the second lower value, a first weight assigned to the first bid value being based on a difference between the first estimated performance and the second estimated performance, a second weight assigned to the second bid value being based on a difference between the second estimated performance and the third estimated performance.

15. The computer readable medium of claim 13, wherein identifying a first lower value comprises identifying a sponsor value at which a first sponsor value of a particular content sponsor associated with the content item falls below a second sponsor value of another content item sponsor that has been selected to provide a content item in one of the at least two presentation positions.

16. The computer readable medium of claim 15, wherein the instructions cause the one or more computers to perform operations comprising determining the second sponsor value based on a current bid associated with the other content sponsor, a cumulative distribution function associated with the other content sponsor, and a probability density function associated with the other content sponsor.

17. The computer readable medium of claim 13, wherein the instructions cause the one or more computers to perform operations comprising identifying a bid value at which the sponsor value meets the first lower value, the identification comprising:
determining, for the particular content sponsor, a cumulative distribution function based on bids that have been previously received from the particular content sponsor;
determining, for the particular content sponsor, a probability density function, based on the cumulative distribution function; and
determining a bid value at which an output of a function of the bid value, the cumulative distribution function, and the probability density function meet the first lower value.

18. The computer readable medium of claim 13, wherein the instructions cause the one or more computers to perform operations comprising identifying a final lower value at which the content item will no longer be presented, wherein determining a price that will be charged comprises determining the price based on the bid that provides the first lower value, the final lower value, and the second estimated performance.
